(19) United States
(12) Patent Application Publication
(10) Pub. No.: US 2024/0116216 A1
(43) Pub. Date: Apr. 11, 2024

(54) PROCESSING SYSTEM AND METHOD FOR PROCESSING A POLYMER-FILLER COMPOSITION, ESPECIALLY A POLYVINYLCHLORIDE-FILLER COMPOSITION

(71) Applicant: Coperion GmbH, Stuttgart (DE)

(72) Inventors: Jürgen Alexander SCHWEIKLE, Neckarsulm (DE); Maria HÖLZEL, Eberdingen (DE)

(73) Assignee: Coperion GmbH, Stuttgart (DE)

(21) Appl. No.: 18/376,205

(22) Filed: Oct. 3, 2023

(30) Foreign Application Priority Data
Oct. 7, 2022 (EP) 22 200 348.5

(51) Int. Cl. B29B 7/46; B29B 7/60; C08J 3/20

(52) U.S. Cl. CPC B29B 7/46; B29B 7/60; C08J 3/203; C08J 2327/06

(57) ABSTRACT

A processing system serves to process a polymer-filler composition, especially a polyvinylchloride-filler composition, and comprises a multi-shaft screw machine, a first feed device and a second feed device. By means of the first feed device, a polymer and a first proportion of a mineral filler are fed into the multi-shaft screw machine. Subsequently, by means of the second feed device, a second proportion of the mineral filler is fed into the multi-shaft screw machine. The gradual mixing-in of the mineral filler achieves a high proportion of the mineral filler in der polymer-filler composition.

### CROSS-REFERENCES TO RELATED APPLICATIONS

This application claims the priority of European Patent Application, Serial No. EP 22 200 348.5, filed Oct. 7, 2022, the content of which is incorporated herein by reference in its entirety as if fully set forth herein.

### FIELD OF THE INVENTION

The invention relates to a processing system and to a method for processing a polymer-filler composition, especially a polyvinylchloride-filler composition. The polymer-filler composition is especially a polymer-filler masterbatch. Correspondingly, the polyvinylchloride-filler composition is especially a polyvinylchloride-filler masterbatch. A masterbatch refers to a composition having a high filler content. The polyvinylchloride (PVC) is preferably a rigid polyvinylchloride (rigid PVC).

### BACKGROUND OF THE INVENTION

EP 2 787 026 A1 discloses a method of processing a polymer-filler masterbatch. A preliminary mixture of a polymer and a mineral filler and additional mineral filler are fed in for processing in a multi-shaft screw machine. The preliminary mixture is referred to as a dryblend. The mineral filler present in the preliminary mixture and the mineral filler fed in additionally have a collective filler content in the polymer-filler masterbatch of 60 phr to 900 phr. The unit “phr” is an abbreviation for “parts per hundred resin” and defines the proportion by mass of the filler based on 100 parts by mass of the polymer.

### SUMMARY OF THE INVENTION

It is an object of the invention to provide a processing system that enables the processing of a homogeneous polymer-filler composition, especially a polyvinylchloride-filler composition, having a high proportion of the mineral filler. The polymer-filler composition or the polyvinylchloride-filler composition is especially a polymer-filler masterbatch or a polyvinylchloride-filler masterbatch. The polyvinylchloride is especially a rigid polyvinylchloride.

This object is achieved by a processing system for processing a polymer-filler composition, especially a polyvinylchloride-filler composition, comprising
a multi-shaft screw machine for processing the polymer-filler composition composed of a polymer and a mineral filler,
a first feed device for feeding the polymer and a first proportion of the mineral filler into the multi-shaft screw machine, further comprising a second feed device for feeding a second proportion of the mineral filler into the multi-shaft screw machine.

The processing system serves for continuous processing of a polymer-filler composition. Because the processing system comprises two feed devices, the mineral filler can thus be fed gradually into the multi-shaft screw machine, such that the mineral filler can be mixed homogeneously and in a high proportion with the polymer or a polymer melt produced from the polymer.

The multi-shaft screw machine is first fed by means of the first feed device with the polymer and a first proportion F₁ of the filler. For the first filler F₁, in particular: 20 phr F₁≤300 phr, especially 40 phr≤F₁≤250 phr, and especially 50 phr≤F₁≤200 phr. The unit “phr” is an abbreviation for “parts per hundred resin” and defines the proportion by mass of the mineral filler based on 100 parts by mass of the polymer.

It has been recognized in accordance with the invention that the first proportion F₁ of the mineral filler is limited in terms of its size, i.e. must not be too high, since the first proportion F₁ has to be mixed in during the melting or plastifying of the polymer. If the first proportion F₁ is too high, problems will occur with the drawing-in or feeding of the polymer and the mineral filler to the multi-shaft screw machine and/or problems in the melting of the polymer and in the mixing-in of the mineral filler. In particular, there is a risk that too much mechanical energy will be introduced into the polymer or the polymer will be oversheared in the melting and mixing-in, such that the polymer is degraded because of an undesirably high temperature.

By means of the second feed device, a second proportion F₂ of the mineral filler can be fed into the multi-shaft screw machine downstream of the feed of the polymer and of the first proportion F₁ of the mineral filler in a conveying direction of the multi-shaft screw machine. For the second proportion F₂, in particular: 300 phr≤F₂≤1100 phr, especially 400 phr≤F₂≤1000 phr, and especially 500≤F₂≤900 phr. The second proportion F₂ is fed into the mixture of the molten polymer and the first proportion F₁ of the mineral filler that has been mixed in. Since the polymer has already been melted and the first proportion F₁ has already been mixed into the molten polymer, it is possible to homogeneously mix in a comparatively high second proportion F₂ in a simple manner, such that the resultant polymer-filler composition includes a high total proportion F_{S} of the mineral filler that has been mixed homogeneously. In particular: F₁<F₂≤20·F₁, especially 2·F₁≤F₂≤10·F₁, and especially 3·F₁≤F₂≤5·F₁.

For the total proportion F_{S}: F_{S}=F₁+F₂. For the total proportion, in particular: 350 phr≤F_{S}≤1400 phr, especially 450 phr≤F_{S}≤1300 phr, and especially 550 phr≤F_{S}≤1200 phr.

The polymer is especially polyvinylchloride (PVC), preferably a rigid polyvinylchloride (rigid PVC). The mineral filler is especially selected from the group of calcium carbonate (CaCO₃), aluminium hydroxide and talc.

The polymer and/or the first proportion F₁ of the mineral filler and/or the second proportion F₂ of the mineral filler is especially in pulverulent form when fed in.

The multi-shaft screw machine especially comprises a housing in which at least two housing bores are formed. The at least two housing bores penetrate one another, especially at least in pairs. One treatment element shaft is disposed in each of the at least two housing bores. The multi-shaft screw machine thus comprises at least two treatment element shafts. The at least two treatment element shafts are preferably in an intermeshing design and/or arrangement. The at least two treatment element shafts are preferably rotationally driveable or rotatable in identical directions of rotation about corresponding axes of rotation. The at least two treatment element shafts and the corresponding axes of rotation are especially aligned parallel to one another. The multi-shaft screw machine is preferably designed as a twin-shaft screw machine. The two treatment element shafts are especially rotationally driveable or rotatable in identical directions of rotation about corresponding axes of rotation.

The processing system especially comprises a control device for controlling the multi-shaft screw machine and/or the first feed device and/or the second feed device.

A processing system in which the multi-shaft screw machine comprises a first feed opening and a second feed opening disposed downstream in a conveying direction, and in which the first feed device opens into the first feed opening and the second feed device opens into the second feed opening, assures the processing of a homogeneous polymer-filler composition having a high proportion of a mineral filler. The multi-shaft screw machine especially comprises a housing in which at least two housing bores are formed. One treatment element shaft is disposed so as to be rotatable about a corresponding axis of rotation in each of the at least two housing bores. The first feed opening and the second feed opening open into the at least two housing bores. The second feed opening is disposed downstream of the first feed opening in the conveying direction of the multi-shaft screw machine. The polymer and the first proportion F₁ of the mineral filler are fed into the multi-shaft screw machine or the at least two housing bores thereof via the first feed opening by means of the first feed device. The second proportion F₂ of the mineral filler is fed into the multi-shaft screw machine or the at least two housing bores thereof via the second feed opening by means of the second feed device. Because the second feed opening is disposed downstream of the first feed opening in the conveying direction, it is possible first to melt the polymer upstream of the second feed opening. The first proportion F₁ of the mineral filler can first be mixed into the polymer melt before the second proportion F₂ of the mineral filler is fed into the multi-shaft screw machine and then mixed into the mixture of the polymer melt and the first proportion F₁ of the filler that has been mixed in.

A processing system in which the multi-shaft screw machine comprises a first feed opening and a second feed opening disposed downstream in a conveying direction, and in which the multi-shaft screw machine forms a melting zone for melting the polymer between the first feed opening and the second feed opening, assures the processing of a homogeneous polymer-filler composition having a high proportion of a mineral filler. The multi-shaft screw machine especially comprises a housing in which at least two housing bores are formed. A respective treatment element shaft is disposed so as to be rotatable about corresponding axes of rotation in the at least two housing bores. The at least two treatment element shafts are preferably rotatable about the axes of rotation in the same directions of rotation. The first feed opening and the second feed opening open into the at least two housing bores. The polymer and the first proportion F₁ of the mineral filler are fed into the multi-shaft screw machine or the at least two housing bores thereof via the first feed opening by means of the first feed device. Because the second feed opening is disposed downstream of the first feed opening in the conveying direction of the multi-shaft screw machine, the polymer can be melted in the melting zone upstream of the second feed opening. The melting zone is preferably designed such that the polymer is melted upstream of the second feed opening and the first proportion F₁ of the mineral filler is at least partly mixed into the molten polymer or polymer melt. The second proportion F₂ of the mineral filler is fed into the multi-shaft screw machine or the at least two housing bores thereof via the second feed opening by means of the second feed device. The second proportion F₂ of the mineral filler can be simply mixed into the polymer melt or into the mixture of the polymer melt and the first proportion F₁ of the mineral filler that has already been mixed in downstream of the second feed opening.

The at least two treatment element shafts have an external diameter D and a length L in the conveying direction. The external diameter D is especially a maximum external diameter. For an L/D ratio, in particular: 32≤L/D≤56, especially 34≤L/D≤44, and especially 36≤L/D≤40.

The melting zone has a length L_{A} in the conveying direction. The melting zone commences at a respective first kneading element of the at least two treatment element shafts and ends at the second feed opening. The length L_{A} is thus defined between the respective first kneading element of the at least two treatment element shafts and the second feed opening. The first kneading element is especially designed as a kneading plate. For an L_{A}/D ratio, in particular: 6≤L_{A}/D≤14, especially 7≤L_{A}/D≤13, and especially 8≤L_{A}/D≤12. If the L_{A}/D ratio is too small, there is the risk that the polymer will not be melted satisfactorily and/or the first proportion F₁ of the mineral filler will not be mixed in satisfactorily. If the L_{A}/D ratio is too high, there is the risk that the polymer will degrade because of an excessively long dwell time.

A processing system in which the first feed device comprises a first feed screw machine, assures the processing of a homogeneous polymer-filler composition having a high proportion of a mineral filler. The first feed screw machine enables, in a simple manner, metered feeding of the polymer and the first proportion F₁ of the mineral filler. The first feed screw machine especially opens into a first feed opening formed in a housing of the multi-shaft screw machine. The first feed screw machine is especially connected laterally to a housing of the multi-shaft screw machine. The first feed screw machine especially opens into at least two housing bores formed in the housing of the multi-shaft screw machine. The first feed screw machine is especially designed as a lateral charging machine. The first feed screw machine especially comprises a housing in which at least one housing bore is formed. One conveying element shaft in each case is disposed in a rotatable manner in the at least one housing bore. The first feed screw machine is preferably of the twin-shaft design. The first feed screw machine especially comprises a housing in which two housing bores are formed. The two housing bores penetrate one another and have the shape of a horizontal eight in cross section. One conveying element shaft is disposed so as to be rotatable in each of the two housing bores. The first feed screw machine thus especially comprises two conveying element shafts. The two conveying element shafts are preferably rotatable or rotatably driveable in the same directions. The conveying of the polymer and the first proportion F₁ of the mineral filler results in at least partial mixing of the first proportion F₁ of the mineral filler with the polymer. The first feed screw machine also enables feeding with a high throughput.

In particular, at least one degassing opening is formed in the housing of the first feed screw machine. Preferably, the first feed device comprises a degassing unit which is connected to the at least one degassing opening. In this way, the pulverulent polymer and/or the first proportion F₁ of the pulverulent mineral filler can be degassed. In particular, air can be removed from the first feed screw machine and/or the polymer and/or the first proportion F₁ of the mineral filler. The degassing allows the polymer and the first proportion F₁ of the mineral filler to be fed to the multi-shaft screw machine in a simple manner with a high throughput. In particular, it is possible to avoid intake problems with the multi-shaft screw machine.

A processing system in which the first feed device comprises a first metering device for metering of a preliminary mixture of the polymer and the mineral filler, and a second metering device for metering of the mineral filler, assures the processing of a homogeneous polymer-filler composition having a high proportion of a mineral filler. The first metering device and/or the second metering device is/are of gravimetric and/or volumetric design. The first metering device serves for metering of a preliminary mixture of the polymer and a base proportion F₁₁ of the mineral filler. The preliminary mixture is also referred to as a dryblend. By contrast, the second metering device serves for metering of an added proportion F₁₂ of the mineral filler. The sum total of the base proportion F₁₁ and the added proportion F₁₂ gives the first proportion F₁ of the mineral filler. Thus: F₁=F₁₁+F₁₂.

For the base proportion F₁₁, in particular: 1 phr≤F₁₁≤70 phr, especially 10 phr≤F₁₁≤60 phr, especially 20 phr≤F₁₁≤50 phr and especially 30 phr≤F₁₁≤40 phr.

For the added proportion F₁₂, in particular: 10 phr≤F₁₂≤230 phr, especially 70 phr≤F₁₂≤200 phr and especially 90 phr≤F₁₂≤180 phr. Preferably: F₁₁≤F₁₂≤20·F₁₁, especially 2·F₁₁≤F₁₂≤15·F₁₁, and especially 3·F₁₁≤F₁₂≤10·F₁₁.

The base proportion F₁₁ in the preliminary mixture is limited in terms of its size, since the polymer and the mineral filler, in the case of an excessively high base proportion F₁₁, will separate on transport or intermediate storage. The added proportion F₁₂ allows the first proportion F₁ of the mineral filler to be increased in a simple manner.

A processing system in which the multi-shaft screw machine and/or the first feed device comprises at least one degassing opening for degassing the polymer and the first proportion of the mineral filler, assures the processing of a homogeneous polymer-filler composition having a high proportion of a mineral filler. The at least one degassing opening enables simple feeding-in of the polymer and of the first proportion F₁ of the mineral filler with a high throughput.

The first feed device, especially the first feed screw machine, preferably has at least one degassing opening. The at least one degassing opening is especially formed in a housing of the first feed screw machine. The first feed device preferably comprises a degassing unit connected to the at least one degassing opening.

The multi-shaft screw machine preferably has at least one degassing opening. The at least one degassing opening is especially disposed in a first intake zone of the multi-shaft screw machine and/or adjacent to a first feed opening of the multi-shaft screw machine. The at least one degassing opening is especially formed in a housing of the multi-shaft screw machine. The at least one degassing opening is especially disposed in a conveying direction of the multi-shaft screw machine upstream of the first feed opening. The multi-shaft screw machine preferably comprises a degassing unit connected to the at least one degassing opening of the multi-shaft screw machine. The degassing unit is especially of atmospheric design. The degassing unit serves in particular for atmospheric degassing or for atmospheric deaeration.

The multi-shaft screw machine preferably comprises a first degassing opening, and the first feed screw machine a second degassing opening. The multi-shaft screw machine preferably comprises a first degassing unit connected to the first degassing opening. The first feed device especially comprises a second degassing unit connected to the second degassing opening. The first degassing unit and/or the second degassing unit is/are especially of atmospheric design. The first degassing unit and/or the second degassing unit serves in particular for atmospheric degassing or for atmospheric deaeration.

The respective degassing unit may comprise a safety guard, a degassing insert, a degassing dome, a degassing screw machine and/or a vacuum pump.

A processing system in which the second feed device comprises a second feed screw machine and/or a third metering device, assures the processing of a homogeneous polymer-filler composition having a high proportion of a mineral filler. The second feed device, in a simple manner, assures metered feeding of the second proportion F₂ of the mineral filler into the multi-shaft screw machine. The third metering device especially opens into the second feed screw machine. The third metering device is of gravimetric or volumetric design. The second feed screw machine especially opens into a second feed opening formed in a housing of the multi-shaft screw machine.

The second feed screw machine is especially connected laterally to a housing of the multi-shaft screw machine. The second feed screw machine especially opens into at least two housing bores formed in the housing of the multi-shaft screw machine. The second feed screw machine is especially designed as a lateral charging machine. The second feed screw machine especially comprises a housing in which at least one housing bore is formed. One screw element shaft is rotatably disposed in each case in the at least one housing bore. The second feed screw machine is preferably of twin-shaft design. The second feed screw machine especially comprises a housing in which two housing bores are formed. The two housing bores penetrate one another and have the shape of a horizontal eight in cross section. One conveying element shaft is rotatably disposed in each of the two housing bores. The second feed screw machine thus especially comprises two conveying element shafts. The two conveying element shafts are preferably rotatable or rotationally driveable in the same directions. The second feed screw machine makes it possible to feed in the second proportion F₂ of the mineral filler with a high throughput.

In particular, at least one degassing opening is formed in the housing of the second feed screw machine. The second feed device preferably comprises a degassing unit connected to the at least one degassing opening. As a result, the second proportion F₂ of the pulverulent mineral filler can be degassed. In particular, air can be removed from the second feed screw machine and/or the second proportion F₂ of the mineral filler. By virtue of the degassing, the second proportion F₂ of the mineral filler can be fed to the multi-shaft screw machine in a simple manner with a high throughput. In particular, it is possible to avoid intake problems with the multi-shaft screw machine.

A processing system in which the multi-shaft screw machine comprises at least one degassing opening for degassing the second proportion of the mineral filler, assures the processing of a homogeneous polymer-filler composition having a high proportion of a mineral filler. The at least one degassing opening enables, in a simple manner, metered addition of the second proportion F₂ of the mineral filler. The second proportion F₂ of the mineral filler is fed into the multi-shaft screw machine in pulverulent form in particular. The degassing especially removes air, such that air fed in with the second proportion F₂ cannot flow upstream in the multi-shaft screw machine and impair the conveying of the molten polymer.

The at least one degassing opening is, in particular, disposed upstream and/or downstream of a second feed opening of the multi-shaft screw machine. The at least one degassing opening is preferably connected to a respective degassing unit. The degassing unit is especially of atmospheric design. The degassing unit serves in particular for atmospheric degassing or for atmospheric deaeration.

The multi-shaft screw machine preferably comprises a third degassing opening disposed downstream of the second feed opening, and a fourth degassing opening disposed in the region of the second feed opening, especially upstream of the second feed opening. The multi-shaft screw machine especially comprises a third degassing unit connected to the third degassing opening, and a fourth degassing unit connected to the fourth degassing opening. The third degassing unit especially comprises a degassing screw machine. The fourth degassing unit is especially of atmospheric design.

A second feed screw machine of the second feed device preferably opens into the second feed opening. The second feed screw machine especially has at least one degassing opening. The multi-shaft screw machine and/or the second feed device preferably comprises a degassing unit connected to the at least one degassing opening. The degassing unit especially comprises a degassing screw machine. The degassing screw machine is especially of twin-shaft design. The degassing screw machine is especially connected laterally to a housing of the multi-shaft screw machine.

The respective degassing unit may comprise a safety guard, a degassing insert, a degassing dome, a degassing screw machine and/or a vacuum pump.

A processing system in which the at least one degassing opening for degassing the second proportion of the mineral filler is disposed in a conveying direction downstream of the second feed opening of the multi-shaft screw machine, assures the processing of a homogeneous polymer-filler composition having a high proportion of a mineral filler. Because at least one degassing opening is disposed downstream of the second feed opening in the conveying direction, degassing can be effected during the mixing of the second proportion F₂ of the mineral filler into the molten polymer. A degassing opening is preferably formed laterally in a housing of the multi-shaft screw machine. To this degassing opening is especially connected a degassing screw machine. A housing of the degassing screw machine is especially connected laterally to a housing of the multi-shaft screw machine. The degassing screw machine is especially of twin-shaft design. This assures degassing during the mixing-in in an efficient manner.

A processing system in which the multi-shaft screw machine forms, between the second feed opening and the at least one degassing opening, a first homogenizing zone for homogenizing the molten polymer and the second proportion of the mineral filler, assures the processing of a homogeneous polymer-filler composition having a high proportion of a mineral filler. The first homogenization zone extends, in the conveying direction, from the second feed opening up to the degassing opening closest to the second feed opening in the downstream direction. The multi-shaft screw machine comprises at least two treatment element shafts having an external diameter D. The external diameter D is especially a maximum external diameter. The first homogenization zone especially has a length Liu in the conveying direction. For an L_{H1}/D ratio, in particular: 4≤L_{H1}≤12, especially 5≤L_{H1}≤11, and especially 6≤L_{H1}/D≤10. In the first homogenization zone, the at least two treatment element shafts each have at least one kneading element. The at least one kneading element is especially designed as a kneading plate, preferably as a kneading block with multiple kneading plates connected to one another in one-piece form. The first homogenization zone serves to homogenize the polymer melt and the first proportion F₁ of the mineral filler that has been mixed therein with the second proportion F₂ of the mineral filler.

A processing system in which the multi-shaft screw machine forms, downstream of the at least one degassing opening in the conveying direction, a second homogenizing zone for homogenizing the molten polymer and the second proportion of the mineral filler, assures the processing of a homogeneous polymer-filler composition having a high proportion of a mineral filler. In the second homogenization zone, in particular, final dispersion of the second proportion F₂ of the mineral filler takes place. After the degassing or removal of the air introduced by the feeding, this is possible in a simple and efficient manner. Because the at least one degassing opening is disposed downstream of the second feed opening in the conveying direction, degassing in the conveying direction or removal of the air introduced in the conveying direction is possible, which does not impair the conveying of the molten polymer and of the first proportion F₁ of the mineral filler that has been mixed in. The second homogenization zone extends between the degassing opening furthest removed from the second feed opening downstream and a discharge opening of the multi-shaft screw machine. The multi-shaft screw machine comprises at least two treatment element shafts having an external diameter D. The external diameter D is especially a maximum external diameter. The second homogenization zone has a length L_{H2} in the conveying direction. For a L_{H2}/D ratio, in particular: 2≤L_{H2}/D≤8, especially 3≤L_{H2}/D≤7, and especially 4≤L_{H2}/D≤6. In the second homogenization zone, the at least two treatment element shafts each comprise at least one kneading element. The at least one kneading element is especially designed as a kneading plate, preferably as a kneading block with multiple kneading plates connected to one another in one-piece form.

A processing system comprising a pressure buildup device for increasing a pressure of the polymer-filler composition which is disposed in a conveying direction downstream of the multi-shaft screw machine, assures the processing of a homogeneous polymer-filler composition having a high proportion of a mineral filler. For pelletization of the polymer-filler composition, an increase in pressure is required. Because of the separate pressure buildup device, the multi-shaft screw machine is not used for pressure buildup. Since the multi-shaft screw machine is used essentially exclusively to process the polymer-filler composition, the polymer-filler composition essentially does not back up before being discharged, which avoids unwanted energy input and resulting degradation of the polymer-filler composition. Excessive backup prior to discharge as a result of a pressure buildup in the multi-shaft screw machine would be disadvantageous since mechanical energy would be introduced into the polymer-filler composition to an unwanted degree, which would increase the temperature of the shear-sensitive polymer-filler composition in an unwanted manner and degrade the polymer-filler composition as a result.

The pressure buildup device especially comprises a single-shaft pressure buildup screw machine and/or a multi-shaft pressure buildup screw machine. The processing system preferably comprises a connecting device that connects the multi-shaft screw machine to the pressure buildup device. The connecting device especially comprises a connecting element, for example a closed shaft that connects at least one discharge opening of the multi-shaft screw machine to a feed opening of the pressure buildup device. The connecting device especially comprises a degassing unit. The degassing unit is connected, for example, to a connecting element, especially a closed shaft. The polymer-filler composition is fed to the pressure buildup device preferably at ambient pressure. For this purpose, for example, the at least one discharge opening for discharge of the polymer-filler composition from the multi-shaft screw machine is disposed above a feed opening of the pressure buildup device in the direction of gravity. The pressure buildup device preferably enables the achievement of an increase in pressure Δp, where, in particular: 1 bar≤Δp≤100 bar, especially 2 bar≤Δp≤80 bar and especially 3 bar≤Δp≤60 bar.

A processing system in which the pressure buildup device comprises a counter-rotating multi-shaft pressure buildup screw machine, assures the processing of a homogeneous polymer-filler composition having a high proportion of a mineral filler. The counter-rotating multi-shaft buildup screw machine comprises a housing in which at least two housing bores are formed. One pressure buildup shaft is rotatably disposed in each of the at least two housing bores. The at least two pressure buildup shafts are counter-rotating, i.e. rotatable or rotationally driveable in opposite directions of rotation. The at least two pressure buildup shafts are preferably of mutually intermeshing design and/or arrangement. The pressure buildup device preferably comprises a counter-rotating twin-shaft pressure buildup screw machine. The multi-shaft pressure buildup screw machine especially forms and intake zone and a pressure buildup zone. The multi-shaft pressure buildup screw machine preferably forms exclusively an intake zone and a pressure buildup zone.

The multi-shaft pressure buildup screw machine especially has at least two pressure buildup shafts. The pressure buildup effect of the multi-shaft pressure buildup screw machine may especially be optimized by means of a slope or a conveying angle of the at least two pressure buildup shafts, a number of flights and/or a flight depth of the at least two pressure buildup shafts and/or a land width and/or a land clearance of the at least two pressure buildup shafts. The pressure buildup effect is increased, for example, in inverse proportion to the slope or conveying angle, in inverse proportion to the flight depth, in inverse proportion to the number of flights and/or in inverse proportion to the land clearance.

The at least two pressure buildup shafts have a length L_{D} and an external diameter D_{D} in the conveying direction. The external diameter D_{D} is especially a maximum external diameter. For an L_{D}/D_{D} ratio, in particular: 3≤L_{D}/D_{D}≤10, especially 4≤L_{D}/D_{D}≤9, and especially 5≤L_{D}/D_{D}≤8.

The polymer-filler composition is viscous because of the high proportion F_{S} of the mineral filler. The counter-rotating multi-shaft pressure buildup screw machine effectively enables a continuous and uniform pressure buildup for a subsequent pelletization.

A processing system comprising a pelletizing device for pelletizing the polymer-filler composition, especially disposed in a conveying direction downstream of the pressure buildup device, assures the processing of a homogeneous polymer-filler composition having a high proportion of a mineral filler. The processing system especially comprises a control device for controlling the pressure buildup device and/or the pelletizing device. The pelletizing device is especially designed and/or actuated by the control device such that pellets or pellet particles having a diameter b and a length c are created. For the diameter b, in particular, 2 mm≤b≤12 mm, especially 3 mm≤b≤10 mm, and especially 4 mm≤b≤8 mm. For the length c, in particular, 0.5 mm≤c≤4 mm, especially 1 mm≤c≤3 mm, and especially 1.5 mm≤c≤2 mm.

Because the pellet particles created have a flat structure, i.e. have a relatively short length c relative to the diameter b, rapid cooling of the molten polymer-filler composition is enabled. This assures a high quality of the pellets, since degradation reactions as a result of excessively long contact with heat are avoided within the pellet particles. The comparatively small pressure buildup by means of the pressure buildup device prevents unwanted compaction of the polymer-filler composition, while maintaining the homogeneity and hence the quality of the polymer-filler composition.

The pellets produced are especially pneumatically conveyed and cooled downstream of the pelletizing device. As a result, a low temperature of the pellets is rapidly attained, preferably of less than 40° C.

It is also an object of the invention to create a method that enables the processing of a homogeneous polymer-filler composition, especially a polyvinylchloride-filler composition, having a high proportion of a mineral filler.

This object is achieved by a method of processing a polymer-filler composition, especially a polyvinylchloride-filler composition, comprising the steps of:
providing a processing system for processing a polymer-filler composition, especially a polyvinylchloride-filler composition,
feeding the polymer and the first proportion of the mineral filler into the multi-shaft screw machine by means of the first feed device,
feeding the second proportion of the mineral filler into the multi-shaft screw machine by means of the second feed device, and
processing the polymer-filler composition composed of the polymer and the mineral filler by means of the multi-shaft screw machine.
   The advantages of the method according to the invention correspond to the already described advantages of the processing system according to the invention. The method can especially be developed with at least one feature described in connection with the processing system.

Further features, advantages and details of the invention will be apparent from the description of a working example that follows.

### BRIEF DESCRIPTION OF THE DRAWING

FIG. 1 shows a partially cross-sectional side view of a processing system with a multi-shaft screw machine for processing a polymer-filler composition, especially a polyvinylchloride-filler composition, a first feed device for feeding in a polymer and a first proportion of a mineral filler and a second feed device for feeding in a second proportion of the mineral filler,

FIG. 2 shows a partly cross-sectional side view of the processing system with a pressure buildup device disposed downstream of the multi-shaft screw machine in the conveying direction and with a pelletizing device,

FIG. 3 shows a partly cross-sectional top view of the multi-shaft screw machine and the feed devices in FIG. 1,

FIG. 4 shows a partly cross-sectional top view of the pressure buildup device and the pelletizing device in FIG. 2,

FIG. 5 shows a section view through the multi-shaft screw machine and the first feed device along the section line V-V in FIG. 3, and

FIG. 6 shows a section view through the multi-shaft screw machine and the second feed device along the section line VI-VI in FIG. 3.

### DESCRIPTION OF THE PREFERRED EMBODIMENTS

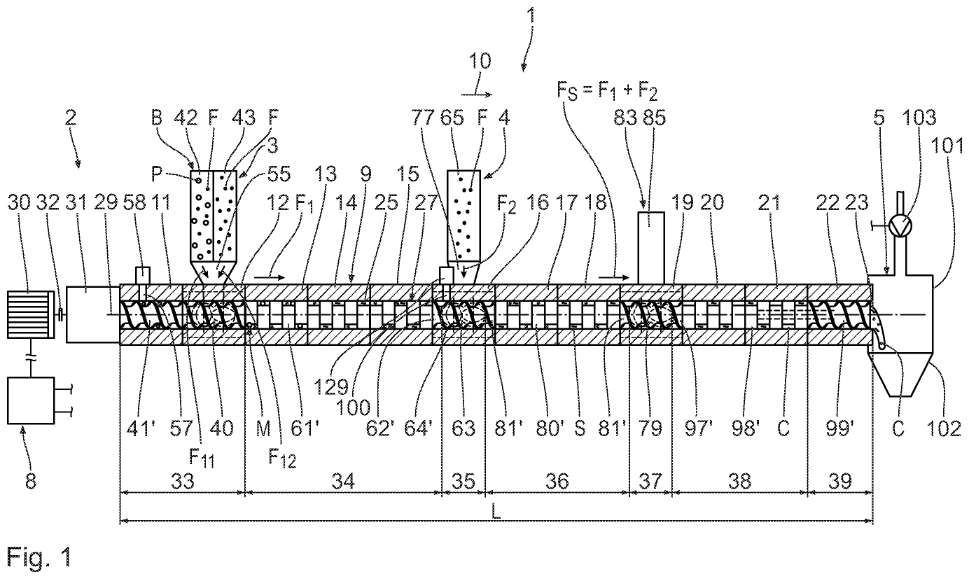

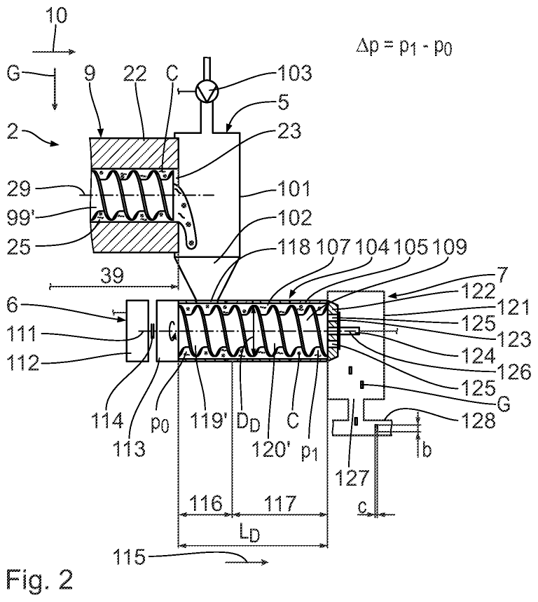

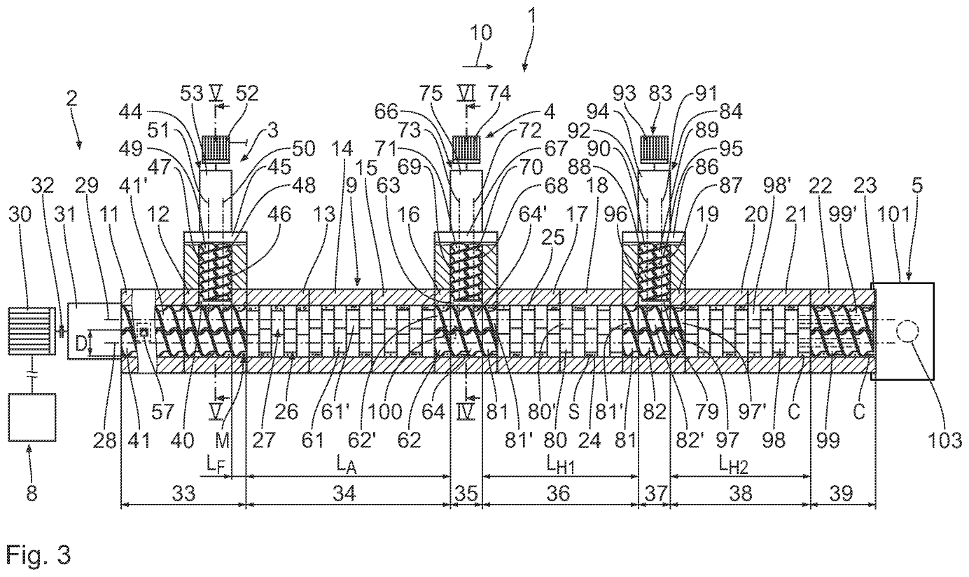

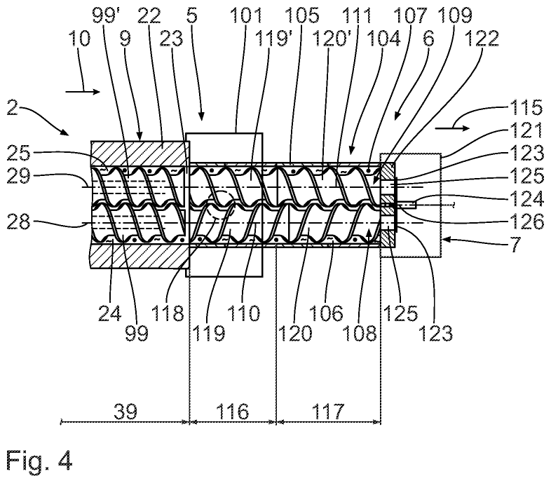

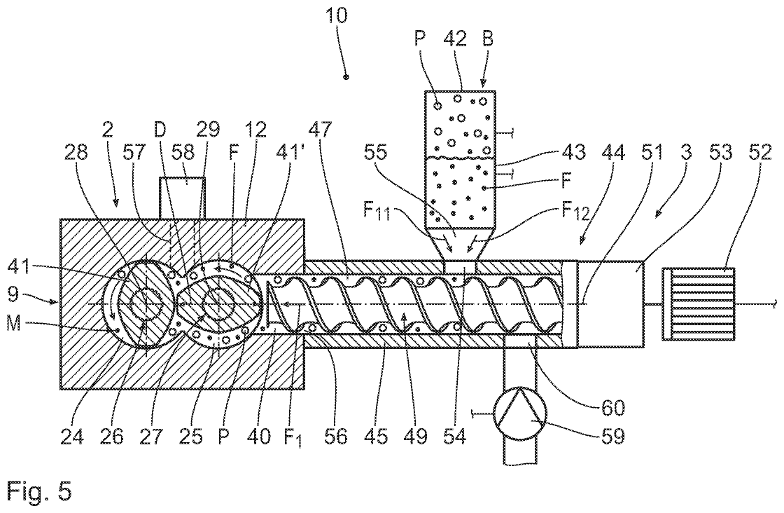

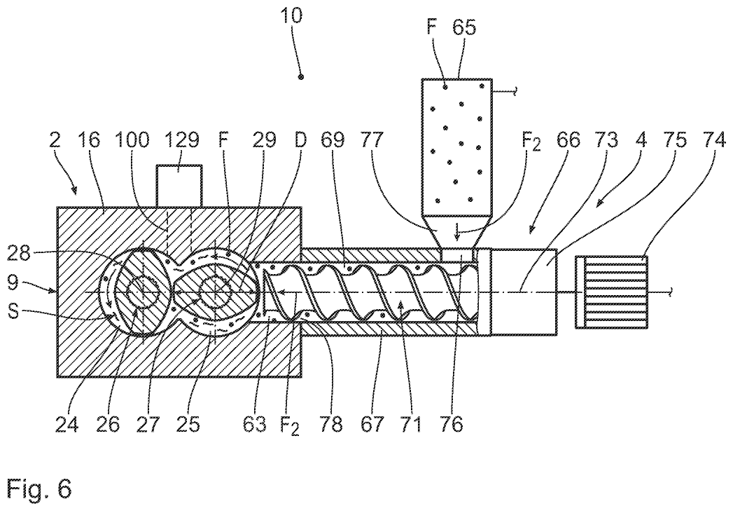

The processing system 1 shown in FIGS. 1 to 6 serves for continuous processing of a polymer-filler composition C, especially a polyvinylchloride-filler composition, composed of a polymer P, especially of polyvinylchloride, and a mineral filler F. The polymer-filler composition C is especially a polymer-filler masterbatch, or the polyvinylchloride-filler composition is especially a polyvinylchloride-filler masterbatch. The polyvinylchloride (PVC) is especially a rigid polyvinylchloride (rigid PVC). The mineral filler F is, for example, calcium carbonate (CaCO₃) or chalk, aluminium hydroxide and/or talc.

The processing system 1 comprises a multi-shaft screw machine 2, a first feed device 3, a second feed device 4, a connecting device 5, a pressure buildup device 6, a pelletizing device 7 and a control device 8.

The multi-shaft screw machine 2 serves for continuous processing of the polymer-filler composition C composed of the polymer P and the mineral filler F. The multi-shaft screw machine 2 is designed as a co-rotating twin-shaft screw machine. The multi-shaft screw machine 2 comprises a housing 9 formed from a plurality of mutually connected housing sections 11 to 22 arranged in succession in a conveying direction 10. The last housing section 22 forms a discharge opening 23. Two mutually parallel and mutually interpenetrating housing bores 24, 25 are formed in the housing 9. The housing bores 24, 25 in cross section have the shape of a horizontal eight.

Two treatment element shafts 26, 27 disposed in the housing bores 24, 25 are rotationally driveable about the corresponding axes of rotation 28, 29 in the same direction of rotation. For rotational driving, the multi-shaft screw machine 2 comprises a drive motor 30 and a distribution transmission 31, between which is disposed a coupling 32. The treatment element shafts 26, 27 are rotationally driven by means of the drive motor 30 via the distribution transmission 31 in the same direction about the axes of rotation 28, 29.

The multi-shaft screw machine 2 forms, in the conveying direction 10, a first intake zone 33, a melting zone 34, a second intake zone 35, a first homogenizing zone 36, a degassing zone 37, a second homogenizing zone 38 and a discharge zone 39.

A first feed opening 40 is formed in the first intake zone 33 in the housing 9. The first feed opening 40 opens laterally into the housing bores 24, 25. The first feed opening 40 is formed, for example, in the housing section 12. In the first intake zone 33, the treatment element shafts 26, 27 comprise conveying elements 41, 41′.

The first feed device 3 serves to feed in the polymer P and a first proportion F₁ of the mineral filler F in the first intake zone 33. The first feed device 3 comprises a first metering device 42, a second metering device 43 and a first feed screw machine 44. The first feed screw machine 44 is designed as a twin-shaft lateral charging machine. The first feed screw machine 44 comprises a housing 45 in which two mutually penetrating housing bores 46, 47 are formed. The housing bores 46, 47 in cross section have the shape of a horizontal eight. In the housing bores 46, 47 are disposed two conveying element shafts 48, 49 that are rotationally driveable in the same directions of rotation about corresponding axes of rotation 50, 51. For rotational driving, the first feed screw machine 44 comprises a drive motor 52 and a distribution transmission 53. A feed funnel 55 opens into a feed opening 54 which is formed in the housing 45. The housing 45 is not closed off at the end and hence forms a charge opening 56 through which the conveying element shafts 48, 49 extend. The housing 45 is connected to the housing 9 of the multi-shaft screw machine 2, such that the charge opening 56 opens into the first feed opening 40. The conveying element shafts 48, 49 extend into the first feed opening 40.

The first metering device 42 serves to meter in a preliminary mixture B of the polymer P and the mineral filler F. The first metering device 42 is of gravimetric or volumetric design. The first metering device 42 opens into the feed funnel 55. The preliminary mixture B is pulverulent. The preliminary mixture B is also referred to as dryblend. The preliminary mixture B contains the polymer P and a base proportion F 11 of the mineral filler F. For the base proportion F₁₁, in particular: 1 phr≤F₁₁≤70 phr, especially 10 phr≤F₁₁≤60 phr, especially 20 phr≤F₁₁≤50 phr and especially 30 phr≤F₁₁≤40 phr. The unit “phr” is an abbreviation for “parts per hundred resin” and defines the proportion by mass of the mineral filler F in relation to 100 parts by mass of the polymer P.

The second metering device 43 serves to meter in an additional proportion F₁₂ of the mineral filler F. The second metering device 43 is of gravimetric or volumetric design. The second metering device 43 opens into the feed funnel 55. For the additional proportion F₁₂, in particular: 10 phr≤F₁₂≤230 phr, especially 70 phr≤F₁₂≤200 phr and especially 90 phr≤F₁₂≤180 phr. Preferably: F₁₁≤F₁₂≤20·F₁₁, especially 2·F₁₁≤F₁₂≤15·F₁₁, and especially 3·F₁₁≤F₁₂≤10·F₁₁.

The first proportion F₁ of the mineral filler F₁ fed in by the first feed screw machine 44 thus adds up to: F₁=F₁₁+F₁₂. For the first proportion F₁, in particular: 20 phr≤F₁≤300 phr, especially 40 phr≤F₁≤250 phr, and especially 50 phr≤F₁≤200 phr.

For degassing of the polymer P and the first proportion F₁ of the mineral filler F, a first degassing opening 57 is formed in the housing 9 of the multi-shaft screw machine 2. The first degassing opening 57 is formed upstream of the first feed opening 40 in the conveying direction 10. The first degassing opening 57 is formed, for example, in the housing section 11. The multi-shaft screw machine 2 comprises a first degassing unit 58 connected to the first degassing opening 57. The first degassing unit 58 serves to remove gas, especially air, by suction or by leading it off from the housing bores 24, 25. The first degassing unit 58 is designed, for example, as an atmospheric degassing unit or atmospheric deaeration unit.

The first feed device 3 comprises a second degassing unit 59 connected to a second degassing opening 60. The second degassing opening 60 is formed in the housing 45 of the first feed screw machine 44. The second degassing unit 59 serves for removal of gas, especially air, by suction or by leading it off from the housing bores 46, 47.

The melting zone 34 serves to melt the polymer P and to mix the first proportion F₁ of the mineral filler F into the molten polymer P or the polymer melt. In the melting zone 34, the treatment element shafts 26, 27 have kneading elements 61, 61′ and conveying elements 62, 62′. The kneading elements 61, 61′ especially comprise kneading blocks with a plurality of kneading plates connected to one another in one-piece form and/or individual kneading plates. The melting zone 34 commences with a first kneading element 61, 61′ in the conveying direction 10 and ends at a second feed opening 63. The second feed opening 63 is elucidated in detail hereinafter.

The treatment element shafts 26, 27 have an external diameter D. The external diameter D is especially a maximum external diameter.

The treatment element shafts 26, 27 have a length L_{F} between the first feed opening 40 and the first kneading element 61, 61′ of the melting zone 34. For an L_{F}/D ratio, in particular: 2≤L_{F}/D≤7, especially 3≤L_{F}/D≤6, and especially 4≤L_{F}/D≤5.

The treatment element shafts 26, 27 have a length L_{A} in the melting zone 34. For a ratio L_{A}/D, in particular: 6≤L_{A}/D≤14, especially 7≤L_{A}/D≤13, and especially 8≤L_{A}/D≤12.

The multi-shaft screw machine 2 has a second feed opening 63 in the second intake zone 35. The second feed opening 63 is disposed downstream of the first feed opening 40 in the conveying direction 10. The second feed opening 63 is formed laterally in the housing 9, for example in the housing section 16, and opens into the housing bores 24, 25. The melting zone 34 is thus formed between the first feed opening 40 and the second feed opening 63.

The second feed device 4 serves to feed a second proportion F₂ of the mineral filler F into the multi-shaft screw machine 2. For this purpose, the second feed device 4 opens into the second feed opening 63. In the second intake zone 35, the treatment element shafts 26, 27 have conveying elements 64, 64′. For the second proportion F₂, in particular: 300 phr≤F₂≤1100 phr, especially 400 phr≤F₂≤1000 phr, and especially 500≤F₂≤900 phr. In particular: F₁≤F₂≤20·F₁, especially 2·F₁≤F₂≤10·F₁, and especially 3·F₁≤F₂≤5·F₁.

The second feed device 4 comprises a third metering device 65 and a second feed screw machine 66. The second feed screw machine 66 is especially designed as a twin-shaft lateral charging machine. The second feed screw machine 66 comprises a housing 67 in which two housing bores 68, 69 are formed. Two conveying element shafts 70, 71 disposed in the housing bores 68, 69 are rotationally driveable in the same direction of rotation about corresponding axes of rotation 72, 73. For rotational driving, the second feed screw machine 66 comprises a drive motor 74 and a distribution transmission 75. The conveying element shafts 70, 71 are rotationally driven in the same direction about the axes of rotation 72, 73 by means of the drive motor 74 via the distribution transmission 75. A feed funnel 77 opens into a feed opening 76 which is formed in the housing 67. The third metering device 65 is of gravimetric or volumetric design. The third metering device 65 opens into the feed funnel 77. The housing 67 is not closed off and forms a charge opening 78. The charge opening 78 opens into the second feed opening 63. For this purpose, the housing 67 is connected to the housing 9 of the multi-shaft screw machine 2. The conveying element shafts 70, 71 stand above the housing 67 and extend into the second feed opening 63.

The second feed device 4 or the second feed screw machine 66 may, in accordance with the first feed screw machine 44, comprise a degassing opening to which the one degassing unit is connected. Reference is made to the corresponding details.

The first homogenization zone 36 serves to mix the second proportion F₂ of the mineral filler F into the molten polymer P and the already mixed in first proportion F₁ of the mineral filler F. The first homogenization zone 36 extends in the conveying direction 10 from the second feed opening 63 as far as a third degassing opening 79. The third degassing opening 79 is elucidated in detail hereinafter. In the first homogenization zone 36, the treatment element shafts 26, 27 comprise kneading elements 80, 80′ and conveying elements 81, 81′. The kneading elements 80, 80′ especially comprise kneading blocks with multiple kneading plates connected to one another in one-piece form and/or individual kneading plates. The first homogenization zone 36 has a length L_{H1} in the conveying direction 10. For an L_{H1}/D ratio, in particular: 4≤L_{H1}/D≤12, especially 5≤L_{H1}/D≤11, and especially 6≤L_{H1}/D≤10.

The degassing zone 37 serves to degas the second proportion F₂ of the mineral filler F. The mineral filler F is fed in pulverulent form through the second feed opening 63 into the housing bores 24, 25. The degassing zone 37 serves in particular to lead off air from the second proportion F₂ of the mineral filler F and from the housing bores 24, 25.

The third degassing opening 79 is formed in the degassing zone 37 in the housing 9. The third degassing opening 79 is thus disposed downstream of the second feed opening 63 in the conveying direction 10. The third degassing opening 79 is formed laterally in the housing 9, for example in the housing section 19. In the degassing zone 37, the treatment element shafts 26, 27 comprise conveying elements 82, 82′.

The multi-shaft screw machine 2 comprises a third degassing unit 83 connected to the third degassing opening 79. The third degassing unit 83 comprises a degassing screw machine 84 and a reduced pressure generator 85. The degassing screw machine 84 is especially designed as a twin-shaft lateral degassing machine. The degassing screw machine 84 comprises a housing 86 in which two housing bores 87, 88 that penetrate one another are formed. The housing bores 87, 88 have the shape of a horizontal eight in cross section. Two conveying element shafts 89, 90 disposed in the housing bores 87, 88 are rotationally driveable in the same direction of rotation about corresponding axes of rotation 91, 92. For rotational driving, the degassing screw machine 84 comprises a drive motor 93 and a distribution transmission 94. The conveying element shafts 89, 90 are rotationally driven in the same direction of rotation about the axes of rotation 91, 92 by means of the drive motor 93 via the distribution transmission 94. A suction opening 95 is formed in the housing 86. The reduced pressure generator 85 is connected to the suction opening 95. The housing 86 is not closed off and forms a connection opening 96. The connection opening 96 opens into the third degassing opening 79. For this purpose, the housing 86 is connected to the housing 9 of the multi-shaft screw machine 2. The conveying element shafts 89, 90 extend through the connection opening 96 into the third degassing opening 79.

In addition, the multi-shaft screw machine 2, in the second intake zone 35, has a fourth degassing opening 100 which is formed upstream of the second feed opening 63 in the conveying direction 10 in the housing 9 or the housing section 16. The multi-shaft screw machine 2 comprises a fourth degassing unit 129 connected to the fourth degassing opening 100. The fourth degassing unit 129 serves for removal of gas, especially air, by suction or by leading it off and/or to lead off gas or air from the second proportion F₂ of the mineral filler F. The fourth degassing unit 129 especially designed as an atmospheric degassing or atmospheric deaeration.

The second homogenization zone 38 serves for further mixing of the second proportion F₂ of the mineral filler F into the molten polymer P and the already mixed-in first proportion F₁ of the mineral filler F and for homogenizing. The further mixing-in and homogenizing especially follow after the degassing of the second proportion F₂ of the mineral filler F. The further mixing-in and homogenizing especially follow the removal of air from the housing bores 24, 25. The second homogenization zone 38 is disposed downstream of the degassing zone 37 or the third degassing opening 79 in the conveying direction 10. The second homogenization zone 38 is also disposed downstream of the first homogenization zone 36 in the conveying direction 10. The treatment element shafts 26, 27 in the second homogenization zone 38 comprise conveying elements 97, 97′ and kneading elements 98, 98′. The kneading elements 98, 98′ especially comprise kneading blocks with kneading plates connected to one another in one-piece form and/or individual kneading plates. The second homogenization zone 38 commences after the third degassing opening 79 and ends with the last kneading element 98, 98′ in the conveying direction 10. The second homogenization zone 38 has a length L_{H2} in the conveying direction 10. For an L_{H2}/D ratio, in particular: 2≤L_{H2}/D≤8, especially 3≤L_{H2}/D≤7, and especially 4≤L_{H2}/D≤6.

The discharge zone 39 serves to discharge polymer-filler composition C created. The polymer-filler composition C has a high proportion F_{S} of the mineral filler F in the discharge zone 39 that has been mixed homogeneously into the molten polymer P. The total proportion F_{S} adds up to: F_{S}=F₁+F₂. For the total proportion F_{S}, in particular: 350 phr≤F_{S}≤1400 phr, especially 450 phr≤F_{S}≤1300 phr, and especially 550 phr≤F_{S}≤1200 phr.

In the discharge zone 39, the treatment element shafts 26, 27 comprise conveying elements 99, 99′. The conveying elements 99, 99′ serve for essentially ambient-pressure discharge of the polymer-filler composition C through the discharge opening 23.

The treatment element shafts 26, 27 have a total length L in the conveying direction 10. For an L/D ratio of the total length L to the external diameter D, in particular: 32≤L/D≤56, especially 34≤L/D≤44, and especially 36≤L/D≤40.

The multi-shaft screw machine 2 is connected to the pressure buildup device 6 by means of the connecting device 5. The connecting device 5 comprises a connecting element 101 designed as a closed shaft. The connecting element 101 is connected to the housing 9 and a feed funnel 102 of the pressure buildup device 6. The connecting device 5 comprises a degassing unit 103 connected to the connecting element 101 or a degassing opening of the connecting element 101.

The pressure buildup device 6 serves to increase a pressure p of the polymer-filler composition C. The pressure buildup device 6 is disposed downstream of the multi-shaft screw machine 2 in the conveying direction 10.

The pressure buildup device 6 comprises a pressure buildup screw machine 104. The pressure buildup screw machine 104 is designed as a counter-rotating multi-shaft pressure buildup screw machine, especially as a counter-rotating twin-shaft pressure buildup screw machine. The pressure buildup screw machine 104 comprises a housing 105 in which two housing bores 106, 107 that penetrate one another are formed. The housing bores 106, 107 have the shape of a horizontal eight in cross section. Pressure buildup shafts 108, 109 that are disposed in the housing bores 106, 107 are rotationally driveable in opposite directions of rotation about corresponding axes of rotation 110, 111. For rotational driving, the pressure buildup device 6 comprises a drive motor 112 and a distribution transmission 113. A coupling 114 is disposed between the drive motor 112 and the distribution transmission 113. The pressure buildup shafts 108, 109 are rotationally driveable in opposite directions about the axes of rotation 110, 111 by means of the drive motor 112 via the distribution transmission 113 and a coupling 114.

The pressure buildup screw machine 104 forms an intake zone 116 and a pressure buildup zone 117 in a conveying direction 115. A feed opening 118 is formed in the intake zone 116 in the housing 105. The feed funnel 102 opens into the feed opening 118. The discharge openings 100 of the multi-shaft screw machine 2 are disposed above the feed opening 118 in relation to the direction G of gravity. As a result, the polymer-filler composition C falls into the feed funnel 102 under gravity after exiting from the discharge opening 23.

In the intake zone 116, the pressure buildup shafts 108, 109 comprise conveying elements 119, 119′. The polymer-filler composition C on entry into the intake zone 116 has a first pressure p₀. In the intake zone 116, the polymer-filler composition C is conveyed to the pressure buildup zone 117.

In the pressure buildup zone 117, the pressure p₀ of the polymer-filler composition C is increased. At a downstream end of the pressure buildup zone 117, the polymer-filler composition C has a pressure p₁. For an increase in pressure Δp: Δp=p₁−p₀. In the pressure buildup zone 117, the pressure buildup shafts 108, 109 have pressure buildup elements 120, 120′ that are especially designed as conveying elements. The pressure buildup screw machine 104 thus has exclusively the intake zone 116 and the pressure buildup zone 117.

For the increase in pressure Δp, in particular: 1 bar≤Δp≤100 bar, especially 2 bar≤Δp≤80 bar and especially 3 bar≤Δp≤60 bar.

For the pressure p₀, in particular: p₀≈pₐₜₘ, where pₐₜₘ denotes atmospheric pressure, which is about 1 bar.

For the pressure p₁, in particular: 1 bar≤p₁≤100 bar, especially 2 bar≤p₁≤80 bar and especially 3 bar≤p₁≤60 bar.

The two pressure buildup shafts 108, 109 have a length L_{D} and an external diameter D_{D} in the conveying direction 115. The external diameter D_{D} is especially a maximum external diameter. For an L_{D}/D_{D} ratio, in particular: 3≤L_{D}/D_{D}≤10, especially 4≤L_{D}/D_{D}≤9, and especially 5≤L_{D}/D_{D}≤8.

The pelletizing device 7 is disposed downstream of the pressure buildup device 6 in the conveying direction 10 or in the conveying direction 115. The pelletizing device 7 comprises a pelletizer housing 121, a perforated plate 122, pelletizing blades 123 and a drive 124. The perforated plate 122 is connected to the housing 105 of the pressure buildup screw machine 104. The perforated plate 122 thus concludes the housing 105. The perforated plate 122 has a multitude of passage openings 125. The passage openings 125 serve to create strands from the polymer-filler composition C. On the side of the perforated plate 122 remote from the pressure buildup screw machine 104 are disposed the pelletizing blades 123. The pelletizing blades 123 are rotationally driveable about a corresponding axis of rotation 126 by means of the drive 124. As a result of the rotation of the pelletizing blades 123, the strands of the polymer-filler composition C are cut into pellet practices G. The pelletizing housing 121 surrounds the perforated plate 122, the pelletizing blades 123 and the drive 124. The pelletizer housing 121 is connected to the housing 105 of the pressure buildup screw machine 104. The pelletizer housing 121 has a discharge opening 127. The discharge opening 127 serves to transport the pellet particles G away. The discharge opening 127 is connected to a transport conduit 128. The transport conduit 128 serves to pneumatically transport the pellet particles G away.

The control device 8 serves to control the processing system 1 and is especially in signal connection with the multi-shaft screw machine 2, the first feed device 3, the second feed device 4, the connecting device 5, the pressure buildup device 6 and the pelletizing device 7.

The way in which the processing system 1 works is as follows:

The first metering device 42 meters the preliminary mixture B into the feed funnel 55 of the first feed screw machine 44. The preliminary mixture B contains the polymer P and the base proportion F₁₁ of the mineral filler F. The throughput of the first metering device 42 is, for example, between 20 kg/h and 200 kg/h. At the same time, the second metering device 43 meters the additional proportion F₁₂ of the mineral filler F into the feed funnel 55 of the first feed screw machine 44. The throughput of the second metering device 43 is, for example, between 10 kg/h and 100 kg/h. The preliminary mixture B and the mineral filler F are pulverulent.

The preliminary mixture B and the additional mineral filler F pass through the feed opening 54 into the housing bores 46, 47. Air present in the housing bores 46, 47 and/or air which is introduced into the housing bores 46, 47 via the feeding of the preliminary mixture B and the additional mineral filler F is removed through the second degassing opening 60 by means of the second degassing unit 59. The preliminary mixture B and the additional mineral filler F are conveyed to the charge opening 56 by means of the conveying element shafts 48, 49 and at least partly mixed with one another to give a mixture M during the conveying.

The mixture M is fed through the first feed opening 40 into the housing bores 24, 25 of the multi-shaft screw machine 2. Air present in the housing bores 24, 25 and/or air present in the mixture M is removed through the first degassing opening 57 by means of the first degassing unit 58.

In the first intake zone 33, the mixture M fed in is conveyed to the melting zone 34 in the conveying direction 10. In the melting zone 34, the polymer P is melted to give a polymer melt S. In the melting zone 34, the polymer melt S is mixed with the first proportion F₁ of the mineral filler F.

In the second intake zone 35, the second proportion F₂ of the mineral filler F is fed through the second feed opening 63 into the housing bores 24, 25. For this purpose, the mineral filler F is fed by means of the third metering device 65 into the second feed screw machine 66. The third metering device 65 is operated, for example, with a throughput between 60 kg/h and 600 kg/h. The second proportion F₂ of the at least one mineral filler F is fed in in pulverulent form. The second proportion F₂ of the mineral filler F passes through the feed funnel 77 and the feed opening 76 into the housing bores 68, 69 and is fed by means of the conveying element shafts 70, 71 through the charge opening 78 and the second feed opening 63 into the multi-shaft screw machine 2. Air present in the housing bores 68, 69 and/or air which is introduced into the housing bores 68, 69 by the feeding-in of the second proportion F₂ of the mineral filler F, and/or air present in the housing bores 24, 25 is removed through the fourth degassing opening 100 by means of the fourth degassing unit 129.

In the first homogenization zone 36, the second proportion F₂ of the mineral filler F is mixed into the polymer melt S and the first proportion F₁ of the mineral filler F that has already been mixed therein. Air present in the housing bores 24, 25 and/or air that has been introduced into the housing bores 24, 25 via the second proportion F₂ of the mineral filler F is pushed in the conveying direction 10 toward the degassing zone 37 and removed through the third degassing opening 79 by means of the third degassing unit 83. The degassing screw machine 84 ensures that the polymer melt S with the mineral filler F mixed therein does not escape through the third degassing opening 79. For this purpose, the conveying element shafts 89, 90 convey toward the third degassing opening 79 such that the polymer melt S and the mineral filler F mixed therein cannot escape through the third degassing opening 79. At the same time, the air is sucked away via the suction opening 95 by means of the reduced pressure generator 85, designed as a vacuum pump for example, through the third degassing opening 79 and the housing bores 87, 88.

In the second homogenization zone 38, the polymer melt S and the mineral filler F are mixed and homogenized once again. At the end of the second homogenization zone 38, the polymer-filler composition C has been formed. The polymer-filler composition C is homogeneous and has the high total proportion F_{S} of the mineral filler F. The total proportion F_{S} adds up to: F_{S}=F₁+F₂.

In the discharge zone 39, the polymer-filler composition C is discharged essentially at ambient pressure through the discharge openings 100 of the discharge plate 23.

The polymer-filler composition C is fed via the connecting device 5 into the feed funnel 102 of the pressure buildup device 6. The connecting element 101 is designed as a closed shaft which is degassed by means of the degassing unit 103, such that no air is introduced when the polymer-filler composition C is fed into the pressure buildup device 6.

Through the feed funnel 102 and the feed opening 118, the polymer-filler composition C passes into the counter-rotating twin-shaft pressure buildup screw machine 104. In the intake zone 116, the polymer-filler composition C is conveyed to the pressure buildup zone 117. The pressure buildup shafts 108, 109 are rotationally driven in opposite directions about the axes of rotation 110, 111 by means of the drive motor 112 via the distribution transmission 113. Because the counter-rotating twin-shaft pressure buildup screw machine 104 has self-contained chamber conveying, backflow or leakage flow of the polymer-filler composition C in the housing bores 106, 107 is minimal. This enables good pressure buildup in the pressure buildup zone 117, without unwanted introduction of mechanical energy into the shear-sensitive polymer-filler composition C. There is an increase in pressure Δp in the counter-rotating twin-shaft pressure buildup screw machine 104, such that the polymer-filler composition C has the pressure p₁ at the end of the pressure buildup zone 117.

The polymer-filler composition C is discharged from the pressure buildup screw machine 104 through the perforated plate 122 of the pelletizing device 7. The passage openings 125 of the perforated plate 122 generate strands of the polymer-filler composition C that are cut into pellet particles G by means of the rotating pelletizing blades 123. The pellet particles G are removed from the pelletizer housing 121 through the removal opening 127 and pneumatically transported away and cooled by means of the transport conduit 128.

The control device controls the pressure buildup device 6 and die pelletizing device 7 in such a way that the pellet particles G have diameter b and length c. The pellet particles G especially have a flat structure, i.e. a high diameter b relative to length c, such that the pellet particles G cool down and solidify rapidly. This assures a high quality of the pelletized polymer-filler composition C.

Because the polymer-filler composition C has a high proportion/total proportion F_{S} of the mineral filler F, it is possible to produce products having improved mechanical properties. Moreover, for the production of the products, it is possible to reduce the amount of the polymer P, which reduces costs and increases sustainability. The polymer P is especially polyvinylchloride (PVC), especially a rigid polyvinylchloride (rigid PVC). The mineral filler F is especially calcium carbonate. The composition is especially a masterbatch.

What is claimed is:

1. A processing system for processing a polymer-filler composition comprising
a multi-shaft screw machine for processing the polymer-filler composition composed of a polymer and a mineral filler,
a first feed device for feeding the polymer and a first proportion of the mineral filler into the multi-shaft screw machine,
comprising a second feed device for feeding a second proportion of the mineral filler into the multi-shaft screw machine.

2. The processing system according to claim 1,
wherein the multi-shaft screw machine comprises a first feed opening and a second feed opening disposed downstream in a conveying direction,
wherein the first feed device opens into the first feed opening and the second feed device opens into the second feed opening.

3. The processing system according to claim 1,
wherein the multi-shaft screw machine comprises a first feed opening and a second feed opening disposed downstream in a conveying direction,
wherein the multi-shaft screw machine forms a melting zone for melting the polymer between the first feed opening and the second feed opening.

4. The processing system according to claim 1,
wherein the first feed device comprises a first feed screw machine.

5. The processing system according to claim 1,
wherein the first feed device comprises a first metering device for metering of a preliminary mixture of the polymer and the mineral filler, and a second metering device for metering of the mineral filler.

6. The processing system according to claim 1,
wherein at least one of the multi-shaft screw machine and the first feed device comprises at least one degassing opening for degassing the polymer and the first proportion of the mineral filler.

7. The processing system according to claim 1,
wherein the second feed device comprises at least one of a second feed screw machine and a third metering device.

8. The processing system according to claim 1,
wherein the multi-shaft screw machine comprises at least one degassing opening for degassing the second proportion of the mineral filler.

9. The processing system according to claim 8,
wherein the at least one degassing opening for degassing the second proportion of the mineral filler is disposed in a conveying direction downstream of the second feed opening of the multi-shaft screw machine.

10. The processing system according to claim 9,
wherein the multi-shaft screw machine forms, between the second feed opening and the at least one degassing opening, a first homogenizing zone for homogenizing the molten polymer and the second proportion of the mineral filler.

11. The processing system according to claim 9,
wherein the multi-shaft screw machine forms, downstream of the at least one degassing opening in the conveying direction, a second homogenizing zone for homogenizing the molten polymer and the second proportion of the mineral filler.

12. The processing system according to claim 1,
comprising a pressure buildup device for increasing a pressure of the polymer-filler composition which is disposed in a conveying direction downstream of the multi-shaft screw machine.

13. The processing system according to claim 12,
wherein the pressure buildup device comprises a counter-rotating multi-shaft pressure buildup screw machine.

14. The processing system according to claim 1,
comprising a pelletizing device for pelletizing the polymer-filler composition, especially disposed in a conveying direction downstream of the pressure buildup device.

15. A method of processing a polymer-filler composition comprising the steps of:
providing a processing system according to claim 1,
feeding the polymer and the first proportion of the mineral filler into the multi-shaft screw machine by means of the first feed device,
feeding the second proportion of the mineral filler into the multi-shaft screw machine by means of the second feed device, and
processing the polymer-filler composition composed of the polymer and the mineral filler by means of the multi-shaft screw machine.

16. The method according to claim 15,
wherein the polymer-filler composition is a polyvinylchloride-filler composition.
